(19) United States
(12) Patent Application Publication
(10) Pub. No.: US 2007/0286928 A1
(43) Pub. Date: Dec. 13, 2007

(54) Product packaging and methods of making the same

(76) Inventors: Gregory Benjamin Sarmas SR., Lake Forest, IL (US); Brandon George Sarmas, Chicago, IL (US); Gregory Benjamin Sarmas JR., Lake Forest, IL (US); Derek John Sarmas, Lake Forest, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/800,909

(22) Filed: May 8, 2007

Related U.S. Application Data
(60) Provisional application No. 60/798,799, filed on May 8, 2006.

(51) Int. Cl. B32B 27/08; B05D 1/36; B05D 3/02; B65D 85/00; B32B 1/02

(52) U.S. Cl. 426/106; 427/372.2; 427/402; 428/34.1; 428/35.7

(57) ABSTRACT

The present invention relates to the packaging of products in order to protect the products from the deleterious effects of heat and/or moisture. One embodiment of the present invention relates to a thermoformable container wherein a moisture-absorbing material is incorporated into or on to the interior surface of the container. The moisture-absorbing materials are water-based, water-activated adhesives. Another embodiment of the present invention relates to a method for reducing or eliminating the effects of heat and/or moisture which are generated within a closed space such as a container by applying a moisture-absorbing material to the container.

This application claims priority from U.S. Provisional Application No. 60/798,799.

### TECHNICAL FIELD

The present invention relates to thermoformable containers for housing moisture sensitive products, and further providing heat retention wherein a moisture-absorbing material is incorporated into or on to the interior surface of said containers. The present invention also relates to a method for reducing or eliminating moisture which is contained within a container or an enclosed space by applying to, or integrating within, the interior surface of said container or enclosed space a moisture-absorbing material. The present invention further relates to methods for making the moisture-sensitive packing materials.

### BACKGROUND OF THE INVENTION

Many different products are shipped, stored, retained or otherwise disposed in packaging, such as plastic packaging, foam packaging, paper packaging or other like packaging. Many products can be damaged by moisture and/or heat. For example, cooked food products may be provided in packaging, whereby an excess of steam may build up within the packaging condensing on the surface of the packaging, leading to deterioration of the cooked food products. Specifically, deep fried food, such as chicken wings, or other like food products, are typically served in a Styrofoam clamshell package, such that customers open the clamshell packaging to obtain the cooked food contained therein. However, steam may condense on the surfaces of the packaging, and heat may build up on the inside of the packaging, causing a deterioration of the cooked food therein. For example, cooked food can get soggy without adequate management of moisture and heat within food packaging. In addition, moisture and/or heat may have a negative influence on the food consistency, color, appearance, taste and other like characteristics.

U.S. Pat. No. 4,127,189 to Shumrak et al. describes a foamed plastic food container having an integral dish and cover, triangular pedestals are formed in the bottom wail of the dish. The height of the pedestals is equal to the stacking height of the container to prevent compacting during storage. Channels between the pedestals allow air circulation about the food in the container to prevent the food from becoming soggy.

Moreover, many electronic, medical products, and frozen food products are stored and shipped within packaging, such as plastic packaging or the like. If exposed to moisture, such as steam or humidity, electronic products can become damaged. Moreover, other products, such as wood, paper products, or other like product, can become damaged if exposed to steam, humidity, or other moisture. The moisture can come from the atmosphere, or may entail off-gassing from the product itself.

A need exists for a material incorporated into packaging for a product for controlling the moisture and/or heat within the product packaging, or container, thereby protecting the product from the damage caused by the moisture and/or heat.

Moreover, susceptors are known in food packaging for the management of heat in the food packaging. Typically, susceptors allow heating of products through inductive heating. For example, susceptors may be utilized within food packaging for allowing a food product to adequately heat, such as during microwave heating, or other like heating. Typically, susceptors are removable inserts provided within food packaging. A need exists for a susceptor material incorporated or embedded directly into the construction and manufacture of the product packaging.

In addition, product packaging typically includes close and lock mechanisms that allow a top or lid material to become engaged to a bottom or product portion of the product packaging. For example, typical food packaging utilizes a clamshell design, whereby a male piece is inserted into a female receptacle to maintain closure of the food packaging. A need exists for a heat sealable material applied to packaging for a product that allows easy enclosure of the product within the packaging without the need for mechanical enclosures.

### SUMMARY OF THE INVENTION

The present invention relates to packaging of products. One embodiment of the present invention relates to absorption of heat and moisture from products, such as food products, electronic products, and other like products. More specifically, the present invention relates to a moisture-absorbing material, such as a coating, film, additive or other like material, incorporated into or on to the product packaging material.

A second embodiment of the present invention relates to containers wherein a moisture-absorbing material is incorporated into or on to the interior surface of said containers.

A third embodiment of the present invention relates to a method of making moisture-sensitive packing materials.

A fourth embodiment of the present invention relates to a susceptor material, designed to intensify the heat preparation cycle of a prepared food, that is embedded into the construction or manufacture of a plastic, plastic composition, paperboard, synthetic paper, or other like material that can be utilized in the packaging of a food product.

A fifth embodiment of the invention relates to a heat sealable coating that is incorporated on to a product package, such that the heat sealable coating allows for the easy sealing of packaging around the product.

One of the major advantages realized by the present invention is that the effects of moisture and/or heat which are generated within an enclosed space such as a container can now be reduced or eliminated by using a hygroscopic material within the container. The hygroscopic material is created by using water-based, water-activated adhesives. Heretofore moisture and/or heat were controlled by applying structural engineering solutions to the container. Other advantages of the present invention are a more functional packaging product (i.e., food container) having better quality and integrity than earlier products, and a product that may be more biodegradable.

In the present invention, a coating, or grafted modular coating, wherein the coating comprises a water-activated adhesive, is affixed to the interior of a container. The container can be made from various polymeric materials or other materials suitable for making containers. When the container is subjected to food-borne heat, heat based moisture is released. When the container is removed from a heating apparatus or simply opened up, a normal observation is of moisture which has condensed to the surface of the food, thus altering the taste, color, shape, and overall integrity of cooked food products contained therein. The water-activated adhesives, which have been affixed to the surface of thermoplastic materials used to construct the containers, and upon release of the off-gassing or moisture from heated food products, absorbs the moisture to the extent that it does not permit moisture to be collected in the interior of the container or reintroduced onto the surface of food products contained therein, thus preventing various aspects of the negative effects that moisture reincorporation imparts upon cooked food products.

It is theorized that the water activated adhesives reorient the thermoplastic container to the extent that it introduces moisture vapor transmission properties, therefore allowing excessive moisture not only to be collected between the water activated adhesive coating and the interior surface of the thermoplastic container, but also that it be released from the container to the exterior of the surroundings.

Additional features and advantages of the present invention are described in, and will be apparent from, the detailed description of the presently preferred embodiments.

### DETAILED DESCRIPTION OF THE PRESENTLY PREFERRED EMBODIMENTS

In a first embodiment of the present invention, a product packaging material comprising a thermoplastic polymeric material, or a mixture of thermoplastic materials and a moisture-absorbing, or hygroscopic, material or materials, are combined to form a container, or package, for a product. It is to be understood that the term “container” or “package” is meant to include any shape, size, color or grade of receptacle for housing or enclosing a product.

More specifically, the packaging material may be made from thermoplastic polymeric materials, such as films or the like, polymeric foam materials, such as Styrofoam, paper packaging, paperboard packaging, cotton or other porous substrate components and other like packaging materials. In addition, the “end-user application” could serve as an advertisement vehicle, wherein marketing and product advertisement could be printed alongside or with water-activated adhesives. Thermoplastic materials useful in the practice of this invention are exemplified, but not limited to, polyethylene, polypropylene, polyethylene tetrephthalate, polystyrene, expanded polystyrene, oriented polystyrene, oriented polylactide, polyvinylchloride, acrylic, acrylonitrile butadiene styrene, poly(lactic acid) and polycarbonate. Products contained therein may include any product where moisture, such as steam and/or humidity and/or heat may damage the product.

Preferably, the product is a food product, although any other product that may be damaged by moisture, steam and/or humidity is contemplated by the present invention. The food product may be a hot, cooked food product, whereby careful management of the moisture within the packaging of the hot, cooked food product allows the product to maintain its freshness, appearance, texture and/or palatability. Of course, other food products, such as vegetables, fruits, or other like food products, that may be damaged by excess moisture, steam and/or humidity, are also contemplated by the present invention.

The moisture-absorbing material comprises a grafted, modular, remoistenable, resin-based polymer, in the form of an adhesive, pellet, micronized particle, microencapsulated particle, and/or film. Preferably, the moisture-absorbing material comprises a grafted, modular, remoistenable film or adhesive. The moisture-absorbing material works to absorb and/or otherwise bind water molecules without the use of desiccant or other like moisture-absorbing additives. Preferred moisture-absorbing materials are exemplified by, but not limited to, water-based or water-activated adhesives and/or remoistenable hot melt adhesive.

The water-based or water-activated adhesives can be categorized into natural or synthetic based adhesives. Natural adhesives are derived from protein (casein) and vegetable (starches, flour) sources. Synthetic adhesives are primarily derived from resin emulsions.

Natural starch-based adhesives, wherein the starch is derived from corn, potato, or tapioca are produced by breaking down the starch molecule into small chain segments by acid hydrolysis. The resulting material can be a starch and/or dextrin. Another natural water-based and/or water-activated compound includes cellulosic-based thickeners, such as found in paints, adhesives and the manufacture of food products such as orange juice.

Synthetic water-based and/or water-activated adhesives are typically resin emulsions, specifically poly(vinyl acetate) emulsions—stable suspensions of poly(vinyl acetate) particles in water. These systems contain, for the most part, water-soluble protective colloids such as poly(vinyl alcohol) or 2-hydroxy cellulose ether, and may further contain plasticizers, fillers, defoamers, and preservatives. Another synthetic water-based and/or water-activated adhesive includes a poly(vinylpyrrolidone)-based adhesive resin.

Hot-melt adhesives are defined as solid adhesives based on thermoplastic polymers, that are applied in the molten state and set to form a bond upon cooling. While almost any thermoplastic polymer can be used, preferred thermoplastic polymers are exemplified by, but are not limited to, copolymers of ethylene and vinyl acetate and low molecular weight polyethers.

Each of the above-described materials (water-based and/or water-activated adhesives) becomes activated or tacked when exposed to water or water vapor. Therefore, any adhesive material which behaves in the manner described above is contemplated by the present invention.

A particularly preferred moisture-absorbing material for use in the present invention is a natural water-based, water-activated adhesive comprising polymeric dextrin. This adhesive is available from Aabbitt Adhesives of Chicago, Ill. under the product code 626-711. Another preferred moisture-absorbing material for use in the present invention is a natural water-based, water-activated adhesive resin emulsion comprising poly(vinyl acetate) and poly(vinyl alcohol). This adhesive is available from Aabbitt Adhesives of Chicago, Ill. under the product code 826-711.

Alternatively, the moisture-absorbing material is incorporated on or into a film, paperboard, synthetic paper, or other like material, which is then incorporated into product packaging. The moisture-absorbing material may be adhered, such as with a pressure-sensitive adhesive, or laminated to the product packaging. Most preferably, the moisture-absorbing material is coated to the surface of the product packaging.

The moisture-absorbing materials of the present invention can also be contained in a device or small product that could be adhered to the inner portion of the product packaging or container to create a hygroscopic environment therein. The device or small product can be made from polymeric materials, paper, paperboard, lightweight or heavy cardboard, synthetic or natural fibers, cotton or other like materials. One side of the device or small product would feature a pressure sensitive adhesive backing with a peel-away protective film that sealed in the affects of the pressure sensitive adhesives until the user desired to attach the moisture absorbing device to the inner portion of the container. This device or small product could be constructed in a flexographic web press. This component of the manufacturing process would resemble that of label construction, wherein sheets of this component could be manufactured to desired specifications. The water-activated adhesive materials would be applied to the outside or non-pressure sensitive adhesive coated portion of this device or small product.

The moisture-absorbing material may be applied over an entire surface of the product packaging, or placed in specific locations on the product packaging. Alternatively, the moisture-absorbing material may be applied to areas that are most exposed to moisture and/or heat from the products. The moisture-absorbing material can be incorporated in specific locations, such as in depressions in the food packaging material.

In addition, the moisture absorbing material can be applied to an imprint in a pattern which is applied to an interior surface of the container. For example, a hexagon or “bee-hive” like pattern may be pressed or imprinted onto the interior surface of the container. The imprinting process can be performed at an in-mold level or the shaped pattern could also be imparted upon the container at both an in-line and off-line level. This design component serves as an adhesive application site, and contains the applied adhesive materials on the surface of the underside of the lid after the adhesive materials have re-moistened as a direct result of the hygroscopic reaction within the internal environment of packaging materials.

The design could be a continuous pattern of hexagon or “bee-hive” like shapes that would cover either a portion or the entire surface of the underside of the lid of the thermoformed container. This design could be achieved by re-tooling the die face of the thermoforming machine to impart the desired configuration of geometric shapes; the shaped patterns could also be imparted upon the materials used to construct thermoformed food containers at both an in-line and off-line level as well; this could also occur at a pre-process level.

The water-activated adhesive materials could be applied in a wide variety of ways, including but not limited to roller application, inner roller extrusion, print, stenciling, hand stamped stenciling, ink jet, contact and non-contact application, tape, label, sprayed, injection, needle, pad print application, ball point application, as well as silk-screening application. The adhesive materials could be dried before the thermoforming process, as it is usually a required component in preparation of sheet or roll stock of thermoplastic materials prior to thermoforming; the water activated adhesive materials could also be dried at a post-process level with fans or commercial drying units off-line; or the adhesive materials could be dried in-mold as a result of the inherent heat involved in thermoforming.

Construction of this component would involve feeding sheet or roll stock of thermoplastic polymer materials into a thermoforming line wherein said materials would be stamped into a characteristic “clam shell” container, for example. The imprinting of the hexagon or “bee-hive” design could be imparted at a pre-process level; also, the pattern could be imprinted by the die-face during the thermoforming process; in addition, the patterned design could be imparted at a post-process level to the thermoformed clamshell container; when relevant, this component's construction should be understood to be possible at an in-line and in-mold level.

At each potential imprinting stage, the water-activated adhesives could also be applied. Moreover, the materials could also be pre-applied to the thermoplastic polymeric materials to pre-occupy the imprinting location prior to it being imprinted. Also, the water-activated adhesive materials could be applied into the imprinted pattern at a post-process level.

It should also be understood that the imprinting process, coupled with the application of adhesive materials, could occur at a pre-determined location on said thermoplastic polymeric sheet or roll stock that would effectuate the patterned design and adhesive application at a staggered rate, only affecting that portion of the thermoformed container that would become the underside of the containers top or upper lid.

The finished component would behave or perform the same basic task of transporting food to and from destinations, though the patterned design imparted upon the container, as described above, solves the distinct problem of moisture management within the internal environment of said food containers.

Tests were performed to investigate the adhesion and tack properties of a number of configurations. Clamshell container one was scored with a dull edged clay forming tool so that a portion of the underside of the container's lid contained a section of hexagon pattern imprints. Clamshell container two was scored at random with the same dull edged clay forming tool so that no clear pattern was present on the underside of the container's lid, such that the surface contained grooves or lines that were imparted or scored into its surface without puncturing the skin of the container, though there was no discernable pattern.

Clamshell container one was coated with water-activated adhesive materials only where hexagon pattern imprints had been imparted on the surface of said container. Clamshell container two was coated with said water-activated adhesive materials in an identical fashion, within each line or figure imparted upon its surface. Clamshell container three was coated at random with a varying size of droplets of said water activated adhesive materials. An equal amount of water activated adhesive material was applied to each clamshell container.

Each container was dried for a period of five minutes, and a standard hair dryer was used for an additional 2 minutes on its lowest setting to assure that the water-activated adhesive materials were sufficiently dried and adhered to the surface of the thermoplastic thermoformed clamshell container.

Subsequent to being dried, two cups of cooked vegetables, along with a small amount of their residual boiling water was placed in one of the smaller compartments located in each container's bottom or base half. Each container was given 15 minutes of stagnate time without being disturbed.

Upon opening each container, a noticeable hygroscopic reaction to the off-gassing of the food contained therein was observed. Each container demonstrated that the adhesive material had re-tacked or had been activated by the material's inherent hygroscopic reaction to heat and moisture.

While each container experienced a similar hygroscopic reaction to its internal environment, there were distinct differences among all three:

Container three, the container having a random application of various sized water activated adhesive materials droplets revealed indications that the glue had absorbed an abundance of water from the air such that the droplets had dramatically expanded in size. A number of the larger droplets exhibited radical features in that they had migrated away from their original application location. It was notable that the droplets of water-activated adhesive materials had absorbed water from the internal environment of the container

Container two demonstrated the hygroscopic reaction of the water-activated adhesive materials, but it did so while also further demonstrating the need for a design or structural component that retains the water-activated adhesive materials after re-activation. Again, like container three, container two's application sites were larger than when first applied and dried. The glue had absorbed such an abundance of water that it spilled outside of its imparted boundaries and onto the un-patterned portion of the clamshell container's top lid.

Container one behaved in an ideal way in that it demonstrated the hygroscopic reaction noticed in all prior experiments, but also because the hexagon pattern that served as the water activated adhesive application point retained the adhesive material, preventing it from expanding during and after hygroscopic absorption had occurred. Further, the application site provided for additional surface area for the absorbed or gathered moisture to congregate within the adhesive material pattern, without forcing the material to become radical or migratory across the container's surface.

It is worthy to note that the controlled conditions under which this experiment was conducted were purposely minimized or immensely reduced; i.e. the physical amount of food materials inserted into said packaging device, as well as the severity of heat which was transmitted by said food product, were as close to negligible as possible. But, even considering the minimal conditions, they still provided for the need to control heat based moisture, and the invention still demonstrated its capability to meet and exceed that need.

The moisture-absorbing material can be applied in a wide variety of ways, including roller application, inner roller extrusion, printing, stenciling, hand-stamped stenciling, ink jet printing, contact and non-contact application, taping, labeling, spraying, injecting, needling, foaming, silk screening, ball-point application, and pad printing application. The moisture-absorbing materials can be applied to sheet and/or roll stocks before the thermoforming process; the moisture-absorbing materials can also be dried before the thermoforming process, or can be dried in-mold as a result of the inherent heat involved in thermoforming.

Alternatively, the moisture-absorbing material is incorporated directly into the packaging material or container. For example, the product packaging material may comprise thermoplastic polymeric material, such as polystyrene. The product packaging or container material may also be selected from, but not limited to, expanded polystyrene, oriented polystyrene, polyethylene, polypropylene, polyethylene tetrephthalate, oriented polylactide, polyvinylchloride, acrylic, acrylonitrile butadiene styrene, poly(lactic acid) and polycarbonate. The moisture-absorbing material comprising the grafted modular remoistenable resin-based polymer may be blended into the thermoplastic polymeric material, and molded to form the product packaging or container. The product packaging or container may be made by, but not limited to, the following thermoforming methods: drape, cavity, plug-assist, pressure, vacuum and twin sheet thermoforming.

The product packaging or container may be made by injection-molding, extruding, coextruding, or may be otherwise made to form the product packaging or container, as conventionally known to those having ordinary skill in the art. The container may be made in different shapes, sizes, colors and grades. The selection of the shape, size, color and grade of the container will, of course, be determined by the product which is housed in the container. A preferred product packaging or container contemplated by the present invention will generally have a concave-shaped bottom portion, and a convex-shaped top portion and wherein each of said portions has exterior and interior surfaces and said top and bottom portions are connected one to another. A particularly preferred container is a clam shell-shaped container. Another embodiment of a product packaging contemplated by the present invention is a blister pack and high visibility packaging for both food and electronics.

The materials used to manufacture the thermoformable packaging or containers of the present invention may optionally be treated by agents or processes in order to render the materials used to form the packaging or container more hydrophilic or otherwise increase the adherence of the moisture-absorbing materials to the surfaces of the packaging or container. These agents or processes can be exemplified, but not limited to, atmospheric plasma treatment, wherein the materials are subjected to specific gases that would enhance the material's hydrophilic adherence and properties, corona treatment, gamma ray treatment and flame treatment.

A method by which surface treatment, such as atmospheric plasma treatment, of the thermoplastic materials is combined with the application of water-activated adhesive materials is contemplated by the present invention. This method is referred to as atmospheric plasma spray or thermal spraying.

This method is advantageous in combining two processes. The first component—atmospheric plasma treatment—is not envisioned to be uniformly required across the whole category of thermoplastic polymeric materials of the moisture-absorbing material, though those materials which are hydrophobic, or inherently averse to adhesion, may require surface treatment in order to allow for water-activated adhesives to adhere to their surface; the second component—water activated adhesive application—is envisioned to apply to each category of materials, whether hydrophilic or hydrophobic. The advantage is in the fact that this component could be utilized at an in-mold, in-line level. Additionally, this component could be utilized at a pre-mold, pre-process level, while the material is readied for thermoforming, or immediately before thermoforming. Further, this component could be utilized at a post-process, post thermoforming level when said thermoplastic containers are thermoformed and in their characteristic shape. In addition, the water-activated adhesive materials utilized in this component would be applied within the spray mechanism in powder form.

In another embodiment of the present invention, two or more layers of the moisture-absorbing material may be applied to the product packaging material (a dual adhesive application). The application of two or more layers enhances moisture absorption and may eliminate the need for the atmospheric plasma treatment or similar type treatments to the product packaging material. It is theorized that one layer of the moisture-absorbing materials adheres to a non-porous surface of the product packaging material and acts as a foundation for the application of the second layer of the moisture-absorbing material. The dual adhesive application envisions that one type of water-activated adhesive may contain the ability to adhere to non-porous hydrophobic surfaces. The water-activated adhesive material with better adhesion properties to such non-porous hydrophobic surfaces could be applied, let dry, and then an additional application of a type of water-activated adhesive material which lacks the ideal adhesion characteristics to non-porous hydrophobic surfaces could take place. Because the favorable material would adhere well to the surface, this “dual-gluing” application would ensure that a hygroscopic affect would take place within the container's internal environment by securing adhesion onto the surface, and applying an additional layer of water activated adhesive so as to ensure water absorption and glue re-tacking.

In another embodiment of the invention, a susceptor material, designed to accelerate the heat preparation cycle of a prepared food through inductive heating, is embedded into the construction of a food product packaging. Specifically, the susceptor material is embedded into the plastic composition, paperboard, synthetic paper, or other like material used in food containers. For example, the susceptor is incorporated into the food product portion of a polystyrene food product clamshell to inductively heat the food product contained therein when heated using an external heat source, such as a microwave oven. Specifically, the susceptor is embedded on the bottom surface of the clamshell food packaging. Alternatively, the susceptor material is embedded on the sides of the clamshell food packaging. In a still alternate embodiment, the susceptor material is incorporated into the sides and bottom portion of a clamshell food packaging.

In a still further alternate embodiment, both the moisture-absorbing material and the susceptor material are incorporated into food product packaging. For example, the moisture-absorbing material, as described above, is incorporated into the top portion of a polystyrene clamshell food package, and the susceptor is embedded into the bottom surface and/or the side surfaces of the clamshell food package. A structural alteration of the die face could impart small notches on the base half of the clamshell as such that a piece of susceptor material could be securely placed within the notches and clamshell. Further, susceptor materials could be adhered to the surface of thermoplastic sheet or roll stock while being made ready for the thermoforming process. When that portion of said sheet or roll stock would be subjected to thermoforming, the adhesive materials would become dried, and the susceptor material securely fastened to the base section of the clamshell. Further still, a pressure sensitive adhesive could be adhered to the bottom portion of the susceptor material, and placed within the bottom portion of said clamshell container at a post-thermoforming level. It is envisioned by the present invention that this component could occur at an in-line or in-mold level, alongside the various other processes or components described herein.

In a further embodiment of the invention, a heat sealable coating is applied to product packaging such that different parts or portions of a product package may adhere together through the application of heat and/or moisture after a product has been placed within the package. For example, a polystyrene clamshell food package may have a heat sealable coating around the perimeter of either or both of the sealing surfaces of the clamshell package (where the top portion and bottom portion meet when closed). When a hot food product is placed within the clamshell package, the top portion and the bottom portion may be closed, and a heat sealable coating may seal the top portion and the bottom portion together upon the application of heat to the package. The heat and/or moisture from the hot food product placed therein may provide sufficient heat and/or moisture to seal the top portion and the bottom portion together.

To construct this component, a polyvinyl acetate based adhesive would be applied to the outer edge of the bottom portion of said thermoformed thermoplastic clamshell container. It could be applied at an in-line and in-mold level, at a pre-process level, and at a post process level. The methods by which the adhesive could be applied encompass a wide variety of ways, and include but are not limited to roller application, inner roller extrusion, print, stenciling, hand stamped stenciling, ink jet, contact and non-contact application, tape, label, sprayed, injection, needle, pad print application, ball point application, as well as silk-screening application. This application of the invention can be applied to automatic or microwave food packaging.

In an alternate embodiment, all three of moisture-absorbing material, the susceptor, and the heat sealable coating, as described above, are applied to a product package or container.

### DETAILED DESCRIPTION OF THE DRAWINGS

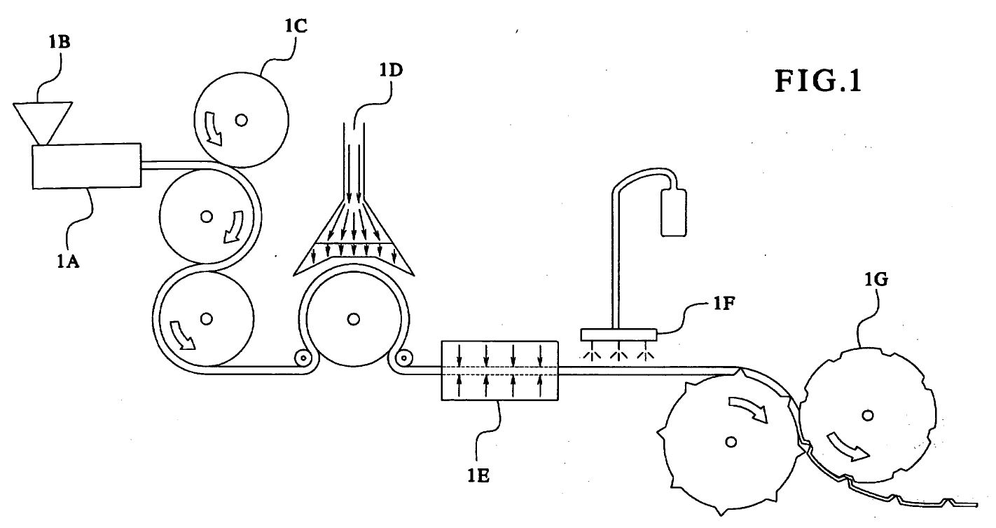

FIGS. 1 to 6 depict various processes for the application of an adhesive to a packaging product material.

FIG. 1 depicts a process for the application of an adhesive to a polymeric packaging product wherein the adhesive is applied prior to the forming of packaging product material. In the process, the polymer in the form of pellets, is fed into extruder (1A) from hopper (1B). The polymer is conveyed through the extruder by screw rotation. Shear energy and electrical heat melt the pellets. Molten polymer is pumped through a die and shaped. The molten polymer then passes over a chill roll (1C) to cool. The cooled polymer then passes through an atmospheric plasma treatment station (1D) and the polymer is reheated in the reheating unit (1E). After reheating of the polymer, the polymer passes to the adhesive application station (1F). Once the polymer leaves the adhesive station, it passes to a vacuum forming station (1G) where the polymer is formed into a product packaging material such as a lid for a food container.

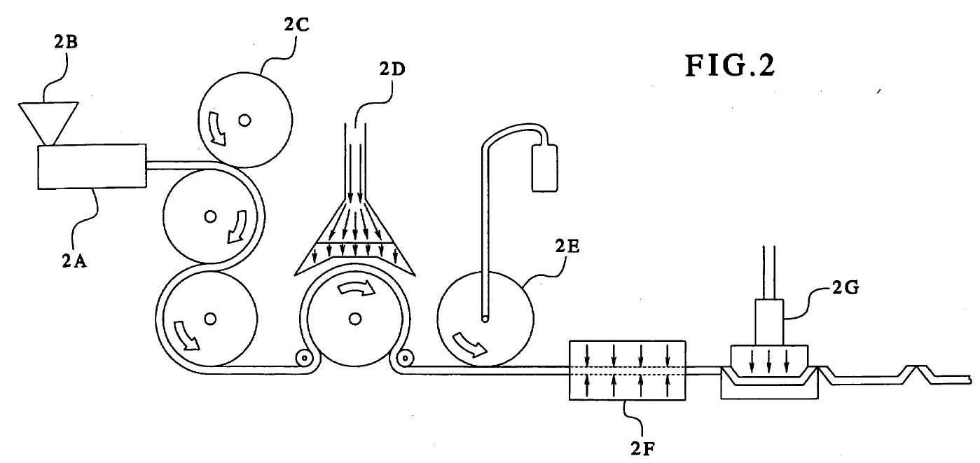

FIG. 2 also depicts an alternative process for the application of an adhesive to a polymeric packaging product wherein the adhesive is applied prior to forming the product packaging material. In the process, the polymer in the form of pellets is fed into extruder (2A) from hopper (2B). The polymer is conveyed through the extruder by screw rotation. Shear energy and electrical heat melt the pellets. Molten polymer is pumped through a die and shaped. The molten polymer then passes over a chill roll (2C) to cool. The cooled polymer then passes through an atmospheric plasma treatment station (2D). After the polymer exits the atmospheric plasma treated station (2D), it passes to the adhesive application station (2E) where the adhesive is applied. Upon exiting the adhesive application station, the polymer is reheated in the reheating unit station (2F). After reheating of the polymer, it passes to the molding station (2G) where it is formed into a product packaging material such as a lid for a food container.

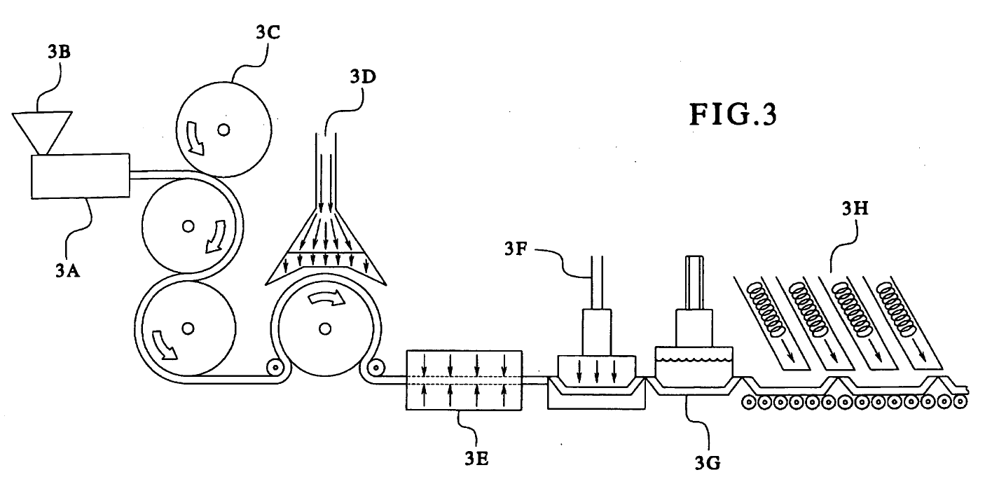

FIG. 3 depicts yet another process for the application of an adhesive to a polymeric packaging product wherein the adhesive is applied after the polymer is molded into a product packaging material. In the process, the polymer in the form of pellets is fed into extruder (3A) from hopper (3B). The polymer is conveyed through the extruder by screw rotation. Shear energy and electrical heat melt the pellets. Molten polymer is pumped through a die and shaped. The molten polymer then passes over a chill roll (3C) to cool. The cooled polymer then passes through an atmospheric plasma treatment station (3D) to reheating station 3(E). Upon exiting the reheating station (3E) the polymer passes to the molding station (3F), where the polymer is molded into a packaging product such as a lid for a container. The molded packaging product then passes to a post mold adhesive application station (3G) where an adhesive is applied to the product packaging material which has been molded into a lid for a container. After application of the adhesive to the product packing material, the adhesive is dried with the use of hot air blowers 3(H).

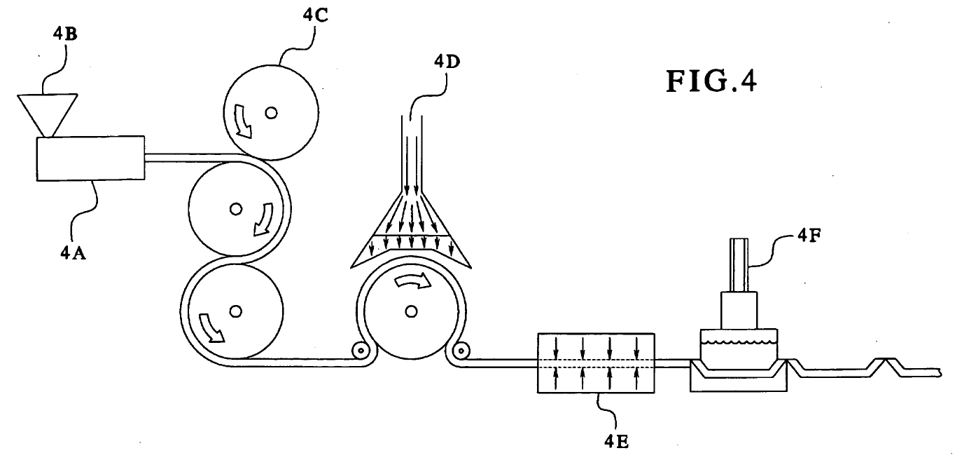

FIG. 4 depicts a process for the application of an adhesive to a polymeric packaging product wherein the adhesive is applied at the molding station simultaneously with the molding of the product packaging material into a lid for a container. In the process, the polymer in the form of pellets, is fed into extruder (4A) from hopper (4B). The polymer is conveyed through the extruder by screw rotation. Shear energy and electrical heat melt the pellets. Molten polymer is pumped through a die and shaped. The molten polymer then passes over a chill roll (4C) to cool. The cooled polymer then passes through an atmospheric plasma treatment station (4D) and then the polymer is reheated in the reheating unit (4E). Once the polymer leaves the reheating station it passes into the molding station (4F) where the adhesive which is inside the male section of the mold plunger is applied simultaneously with the molding of polymers into the shape of a container.

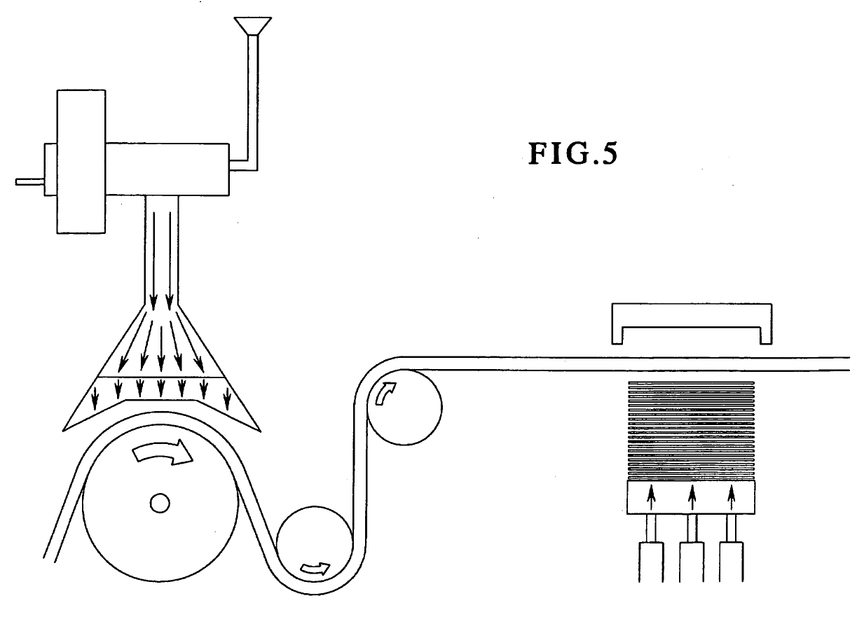

FIG. 5 depicts a process for the application of an adhesive of the present invention to a polymeric packaging product wherein the adhesive is part of a label having a pressure sensitive adhesive on the backside and the water-activated adhesive on the front side. The labels are applied to the inner surface of the packaging product with a spring-loaded template through a cavity in the male mold, as the web of polymeric material is thermoformed by engagement of the female mold over the male mold. Further, adhesive may be applied around the periphery of the packaging product via the male mold, as indicated by the “x” pattern on the male mold.

Alternatively, instead of an adhesive label applied to the inside surface of the packaging product, as described above and shown in FIG. 5, a stencil having a design pattern may be applied to the inside surface of a packaging product, whereby said stencil applies the water-activated adhesive onto the surface of the packaging product.

Moreover, a susceptor may be applied to the polymeric material, such as in a location that serves as a bottom tray of the packaging product, and the water-activated adhesive applied to the top lid of the packaging product. The susceptor may be adhered to the surface of the polymeric material via an adhesive, or may fit into notches provided in the polymeric material.

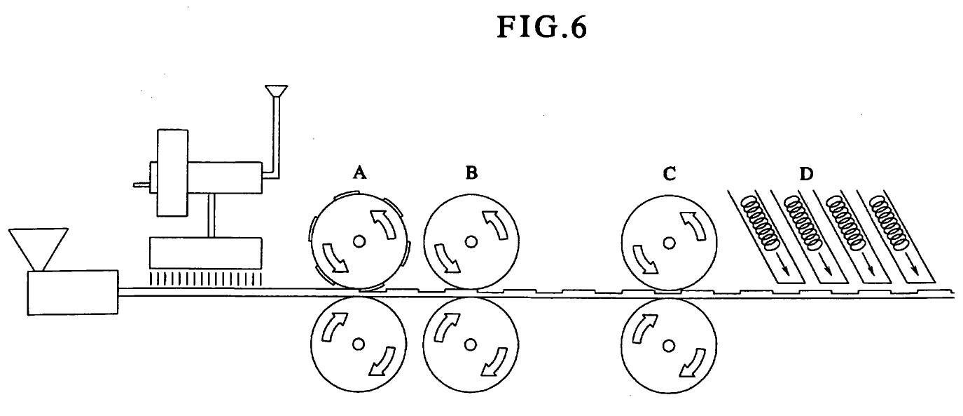

FIG. 6 depicts a process for the application of an adhesive of the present invention to a polymeric packaging product wherein the adhesive is applied within a pattern. In the process, the polymeric material is passed over an engraved pattern roller (A) wherein a pattern is applied to the polymeric material. The pattern may be imprinted or otherwise impressed into the polymeric material. The pattern may be any design, including, preferably, a hexagon pattern. After the pattern is applied to the polymeric material the patterned polymeric material is coated with an adhesive (B). The adhesive material may further be applied generally over the patterned polymeric material, or may be applied to specific regions thereof, such as over the pattern imprinted onto the polymeric material, or otherwise in registry with the pattern imprinted onto the polymeric material. Optionally, the adhesive-coated patterned polymeric material may be further coated with the same or a second adhesive (C). After application of the adhesive coatings the adhesive is dried at drying station (D). The polymeric material may then be thermoformed into packaging products.

### EXAMPLE

Food packaging was manufactured from composite styrene, or other like material, as a sheet and molded to form a folding clamshell package for foods, such as hot foods. Aabbitt Adhesives, Inc. product no. 626-711 believed to be a natural water-based, water-activated adhesive comprising polymeric dextrin, or 826-711 believed to be a natural water-based, water-activated adhesive resin comprising poly(vinyl acetate) and poly(vinyl alcohol) (“adhesive coating”), was coated to the top lid portion of the clam shell packaging. The adhesive coating was allowed to dry. Hot cooked food was then added to the clamshell packaging, whereupon the clamshell packaging was closed over the hot cooked food. The solids present in the adhesive coating absorbed the moisture from the hot cooked food, thereby protecting the food from degradation due to exposure to the moisture within the clamshell packaging.

### OTHER EMBODIMENTS

Moisture-absorbing material, as described herein, may be utilized in various embodiments for controlling moisture content in an enclosed space. Moreover, moisture-absorbing material may be combined with so-called eco-friendly or environmentally-friendly polymer materials, such as biodegradable poly(lactic acid)-based polymers, to impart moisture-absorbing capabilities to biodegradable containers. By incorporating water-activated adhesives onto the surface, or within the component structure of poly(lacticacid) (“PLA”) and other like biodegradable polymeric materials, the inherent degradation properties of that category of materials would be enhanced; consequently, the lifespan of spent biodegradable polymer materials may be reduced.

PLA, is a biodegradable polymer; specifically, it is one distinct type of material within a general class of bioabsorbable polyesters that possess favorable biocompatibility which has been utilized as a bioabsorbable material in the medical and pharmaceutical fields, as well as a manufacturing material in a wide variety of other areas. Environmental concerns have prompted firms to seek manufacturing materials and components which reduce, alleviate, or altogether eliminate the arguably negative environmental impact of non-biodegradable polymeric manufacturing materials. PLA and other like biodegradable manufacturing materials are used to construct packaging, containers, and other like applications known to have a minimal affect on the environment wherein the product is used and eventually disposed of.

PLA is manufactured by converting corn starch into lactic acid, which then undergoes polymerization. Biodegradable polymers are utilized in a wide variety of applications. Within the food and food packaging industry, PLA has been used to construct containers such as cups, bowls, plates, cutlery, bags, “punnets” or meat trays, and clamshells. Outside of the food industry, PLA is used to construct items such as packaging materials that include, but are not limited to, shipping peanuts, pads, bags, rolls, boxes, and the like. In addition, PLA is used to construct clothing hangers, newspaper bags, shopping bags. In the waste and disposal industries, PLA is used to construct garbage bags, food waste bags, compost bags, and pet waste bags. In addition, PLA has been utilized in constructing large-scale compost systems which store organic waste materials for a pre-determined period of time so as to bring about biodegradation and the formation of “mulch” or compost for agricultural purposes. These applications are not to be understood as limiting the use of PLA, though they are common applications envisioned by this invention. While the benefits of these manufacturing materials are evident in their inherent organic, renewable, and biodegradable properties, as a grade or category of materials, biodegradable polymers are typically slow to degrade. Slow rates of degradation provide for an extended “life-span” subsequent to a PLA product's end-user application. As a result, the qualitative advantage of these materials over traditional polymeric materials is compromised and the value added to PLA materials as a result of its comparative advantage concerning end-user disposal becomes diminished or in some way reduced.

At the point of end-user disposal, products or containers manufactured with PLA or other like biodegradable polymers undergo waste management procedures that aim to break down or initiate biodegradation within compost systems or waste sites. PLA is comprised of polylactic acid, a repeating chain of lactic acid, which undergoes or is subjected to composting in a two step process. First, the moisture and heat in the compost pile attack the PLA polymer chains and split them apart, creating smaller polymers, and finally, lactic acid. Microorganisms in compost and soil consume the smaller polymer fragments and lactic acid as nutrients. But because of the extended life-span of PLA and other like biodegradable polymers, composting and other disposal methods are prolonged, detracting value from their inherent biodegradability.

PLA and other like biodegradable polymers are fully biodegradable given that the disposal method employs proper time and technique. When disposing of PLA and other like biodegradable polymers, decomposition is prolonged or extended, and a need exists to enhance the initiation and rate at which these materials begin and undergo biodegradation. This invention applies in all end-user disposal methods, regardless of the intended or a mandated method, i.e., this invention applies to any disposal method, because the adhesive materials enhance degradation in the presence of or absence of water or atmospheric moisture.

It is theorized that by incorporating water-activated adhesives onto the surface, or within the component structure of PLA and other like biodegradable polymeric materials the inherent degradation properties of that category of materials would be enhanced. Consequently, the life span of spent biodegradable polymer materials would be reduced.

There are a variety of methods for manufacturing this product. Because PLA and other like biodegradable materials are utilized in a wide range of manufacturing applications and industries, the methods will vary from application to application, or industry to industry.

One embodiment of this invention encompasses thermoformed thermoplastic containers constructed with sheet or roll stock of PLA or other like biodegradable materials, as well as non biodegradable thermoplastic polymers. Typically, a sheet is fed into a thermoforming machine where pressure and heat is utilized to stamp, impart or otherwise effectuate a desired shape or distinct functional composition of the final thermoformed material. For example, containers are manufactured for food packaging using thermoforming machines whereby sheet or roll stock comprised of either PLA and other like biodegradable polymeric materials or non biodegradable polymeric materials are fed into a thermoforming machine and stamped into a “clamshell” container intended to be used as a take-out food storage implement.

Methods by which water activated adhesive materials could be applied to the thermoplastic materials-whether at a pre-process pre-thermoforming stage, an in-line or in-mold level, or at a post-process or post thermoforming stage, include, but are not limited to, roller application, inner roller extrusion, print, stenciling, hand stamped stenciling, ink jet, contact and non-contact application, tape, label, sprayed, injection, needle, pad print application, ball point application, as well as silk-screening applications. The application of adhesive materials could be applied to sheet and/or roll stocks before the thermoforming process. The adhesive materials could be dried before the thermoforming process, as it is usually a required component in preparation of sheet or roll stock of thermoplastic materials prior to thermoforming. The water activated adhesive materials could also be dried at a post-process level with fans or commercial drying units off-line. Or the adhesive materials could be dried in-mold as a result of the inherent heat involved in thermoforming.

The present invention envisions applying water-activated adhesives, as described herein, onto the surface of PLA or other like biodegradable polymer materials at an in-line, in-mold level, during pre-manufacturing drying procedures—which are standard requirements to allow for PLA and other like polymeric materials to cure, and at a post manufacture level after thermoforming has occurred.

Further, the present invention envisions applying adhesive materials within the component structure of PLA and other like biodegradable polymeric materials used to construct the above mentioned categories of items. This could be achieved by microencapsulating water-activated adhesive products within PLA or other like biodegradable polymeric materials at the time of or subsequent to extrusion.

Further still, this invention envisions that PLA and other like biodegradable materials may require surface modification as to allow for hydrophilic characteristics to take form on the surface of such materials. Surface treatment may include, but is not to be limited to atmospheric plasma treatment, whereby the PLA and other like biodegradable polymeric materials are subjected to a predetermined mixture or solution of gasses that render their surface hydrophilic, or susceptible to adhesion. Adhesive materials could then be applied at an in-line, in-mold level, or subsequent to thermoforming when the container or packaging product has taken its final shape and form.

A further embodiment of this invention is the combination of surface treatment and the application of adhesive materials, known to those skilled in the art as “thermal spraying.” atmospheric plasma spray is one of several methods of thermal spray technology. In this process, PLA and other like biodegradable polymeric materials are simultaneously subjected to a predetermined mixture or solution of gasses and adhesive materials, or other water activated materials that possess hygroscopic properties. This process would render the surface of such materials, if deemed necessary, hydrophilic, and would, in tandem, incorporate adhesive materials onto the surface of the treated surface.

By applying adhesives of the water activated classification, or other like materials with hygroscopic properties to the materials intended to construct thermoformed containers, or already thermoformed containers, this invention solves the problem and meets the need of controlling heat based moisture that is otherwise re-incorporated into or onto the contents of the thermoformed container by droplets of water which condensation forces to gather on the container's underside lid.

A method in which adhesive materials could be deposited or placed within the component structure of said thermoplastic foam containers is the microencapsulation of water activated adhesive materials or other materials containing hygroscopic properties within PLA or other like biodegradable polymer materials. Microencapsulation is the process by which individual particles or droplets of an active material are isolated by being surrounded by a coating to produce capsules within the micrometer to millimeter range, known to those skilled in the art as “microcapsules.” These microcapsules release their contents at a later time when appropriate to the individual application or material in which they are located. It is believed that the microencapsulation of water-activated adhesive materials within the materials which are used to construct PLA and other like biodegradable polymers would be a suitable and easily achieved method by which this invention could be constructed.

In order to achieve the intended results of incorporating water-activated adhesive materials within the component structure of PLA and other like biodegradable polymer materials, a coating must be selected which is compatible and neutral to said water activated adhesive product. The adhesive materials would be encapsulated within a sphere of material indigenous to the adhesive's composition, i.e. the encapsulation material must or ideally will be chemically related to any given water activated adhesive material. One such indigenous coating material would be polyvinyl alcohol (PVA). PVA could be utilized to encapsulate said water activated adhesive materials within the component structure of PLA and other like biodegradable materials so as to impart the desired initiation and enhancement of biodegradation once said material was subjected to exposure to liquid water or atmospheric based moisture. When exposed to said moisture, the PVA sphere surrounding the water-activated adhesive materials would rupture, exposing the adhesive materials to said moisture, inhibiting hygroscopic moisture absorption, thus initiating and enhancing the biodegradation of said PLA and other like biodegradable materials.

In a further embodiment of this invention, adhesive materials would be both coated or otherwise incorporated onto the surface of PLA or other like biodegradable materials before thermoforming, during thermoforming at an in-line in-mold level, or after thermoforming as well as microencapsulated within the component structure of the PLA or other like biodegradable polymer materials.

By incorporating water-activated adhesive materials, and other like materials that contain hygroscopic properties, whether it be by coating or otherwise imparting said materials at a preformed, in-line, or in-mold level on the surface of pre-thermoformed PLA sheet or roll stock, as well as other like biodegradable polymer materials in the sheet or roll stock form, or by the microencapsulation of said water activated adhesives and other like materials possessing hygroscopic properties within PLA sheet or roll stock, as well as other like biodegradable polymer materials in the sheet or roll stock form, or by applying said water activated adhesives and other like materials possessing hygroscopic properties onto the surface of thermoformed container packaging constructed with PLA sheet or roll stock, as well as other like biodegradable polymer materials in the sheet or roll stock form, this invention addresses the problem or need to enhance the initiation and rate of biodegradation at an end-user disposal level.

It is believed that providing liquid water and heat based or atmospheric moisture rapidly in contact with the molecular composition of PLA and other like biodegradable polymer materials at an end-user disposal level will enhance the material's biodegradable properties, and reduce the life-span of said materials.

The following is a list of further embodiments and general applications of the present invention.
1. Disposables: hazardous waste containers and bags, blood and fluid waste receptacles, diapers, sanitary napkins, tampons, wound treatment devices, hospital gowns, hospital bed sheets, hospital bed pads, surgical dressings, surgical sheets, sterile clothing (sweat retention feature), hospital “scrubs”, surgeon's cap, face masks and waste bags.
2. Shipping: thermoplastic shipping peanuts, pads, rolls, protective holdings, bags, boxes, such as corrugated cardboard boxes (within corrugated walls), within shipping crates, rail cars, aircraft cabins, vessel cabins and truck trailer cabins.
3. Product Packaging: electronics, medication bottles (similar to silica salt insert packets), food containers and paper and office supply packaging.
4. Electronics: within moisture or water sensitive electronic or mechanical equipment and devices. Also, within the electronic control units that operate or control dishwashers, cars, computers and other water intensive machines.
5. Pizza Boxes: within pizza boxes and all other non thermoformed food transportation packaging.
6. Gardening: within thermoplastic or biodegradable polymer soil pellets and cardboard or disposable flower pots.
7. Construction: within drywall or alternate interior construction materials; within thermoplastic or foam materials used as insulation, especially beneath dry-vit coating mechanisms; on the surface of construction paper and synthetic exterior wall enclosures; within the component structure of fiberglass insulation materials, especially with respect to moisture control and management in attics and crawl spaces (so as to prevent mold and mildew damage to the interior structure of housing).

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

What is claimed is:

1. A thermoformed container for housing a moisture sensitive product comprising:
a concave-shaped bottom portion and a convex-shaped top portion wherein said concave-shaped bottom portion and said convex-shaped top portion each have exterior and interior surfaces; and wherein said concave-shaped bottom portion and said convex-shaped top portion are connected one to another, and wherein a moisture-absorbing material is incorporated into, or on to, at least one of said interior surfaces of said thermoformed container.

2. The thermoformed container according to claim 1, wherein said moisture-absorbing material comprises a grafted, modular, remoistenable resin-based polymer.

3. The thermoformed container according to claim 2, wherein the polymer is in the form of a water-activated adhesive.

4. The thermoformed container according to the claim 1 wherein the water-activated adhesives are selected from the group consisting of natural adhesives, synthetic adhesives and remoistenable hot melt adhesives.

5. The thermoformed container according to claim 3, wherein the water-activated adhesive comprises polymeric dextrin, or a derivative thereof.

6. The thermoformed container according to claim 3, wherein the water-activated adhesive comprises a resin emulsion of poly(vinyl acetate) and poly(vinyl alcohol).

7. The thermoformed container according to claim 1, wherein the concave-shaped bottom portion houses a moisture-sensitive product.

8. The thermoformed container according to claim 7, wherein the moisture-sensitive product is selected from the group consisting of food products, electronic products, and medical products.

9. The thermoformed container according to claim 8, wherein the moisture-sensitive product is a food product.

10. The thermoformed container according to claim 1, wherein the moisture-absorbing material is incorporated on to at least one of said interior surfaces of said thermoformed container by laminating or coating.

11. The thermoformed container according to claim 1, having the shape of a clamshell.

12. The thermoformed container according to claim 1 wherein the material comprising said thermoformed container is selected from the group consisting of polyethylene, polypropylene, polyethylene terephthalate, polystyrene, expanded polystyrene, oriented polystyrene, oriented polylactide, polyvinylchloride, acrylic, acrylonitrile butadiene styrene, poly(lactic acid) and polycarbonate.

13. The thermoformed container according to claim 12 wherein the material is poly(lactic acid).

14. The thermoformed container according to claim 1 wherein the moisture-absorbing material is applied in the form of a pattern.

15. A method for reducing or eliminating moisture which is contained within a container by applying to, or integrating within, the interior surface of said container a moisture-absorbing material.

16. The method according to claim 15 wherein the moisture absorbing material is a grafted, modular, remoistenable resin-based polymer.

17. The method according to claim 16 wherein the polymer is a water-activated adhesive.

18. The method of claim 15 wherein the water-activated adhesive is selected from the group consisting of natural adhesives, synthetic adhesives and remoistenable hot melt adhesives.

19. The method according to claim 18, wherein the adhesive comprises polymeric dextrin.

20. The method according to claim 18, wherein the adhesive comprises a resin emulsion of poly(vinyl acetate) and poly(vinyl alcohol).

21. The method according to claim 15, wherein the moisture-absorbing material is coated on to the interior surface of the container.

22. The method according to claim 15, wherein the moisture-absorbing material is integrated within the composition forming the container.

23. The method according to claim 15, wherein the moisture-absorbing material is affixed to the interior surface of said container by means of a label.

24. The method according to claim 15, wherein the moisture-absorbing material is protected from exposure to the environment by a protective membrane.

25. The method according to claim 15, wherein the container is thermoformable.

26. A method of making a thermoformed lid characterized by the presence of a adhesive affixed to the inside surface of said lid comprising the following steps:
(a) extruding a molten polymeric material;
(b) passing said molten polymeric material from step a over a chill roller;
(c) passing the cooled polymeric material from step b through an atmospheric plasma treatment station;
(d) reheating the treated polymeric material from step c;
(e) molding the molten polymeric material from step d into the shape of a lid;
(f) coating an adhesive material on to the inside surface of said lid; and
(g) drying of the adhesive material.
